(19) United States
(12) Patent Application Publication
(10) Pub. No.: US 2012/0139817 A1
(43) Pub. Date: Jun. 7, 2012

(54) HEAD UP DISPLAY SYSTEM

(75) Inventor: Jonathan Paul Freeman, Cambridgeshire (GB)

(73) Assignee: BAE SYSTEMS PLC, London (GB)

(21) Appl. No.: 13/389,704

(22) PCT Filed: Aug. 10, 2010
(86) PCT No.: PCT/GB10/51321

§ 371 Date: Feb. 9, 2012

(30) Foreign Application Priority Data
Aug. 13, 2009 (GB) 0914177.1
Aug. 19, 2009 (EP) 09275061.1

(51) Int. Cl. G09G 5/00

(52) U.S. Cl. 345/8

(57) ABSTRACT

A head up display apparatus is disclosed for projecting an image upon a screen. The apparatus comprises a signal processing system, comprising an image projector for projecting an image to a partially reflective screen, the screen being configured substantially in front of an eye of a user of the display apparatus. The apparatus further comprises a beam steering arrangement for steering the projected image substantially at an exit pupil of the system, upon the screen, and a pupil tracking arrangement for tracking a pupil of the users eye such that the projected image remains directed at the pupil of the user as the user adjusts their line of sight.

### FIELD OF THE INVENTION

The present invention relates to head up display systems and to head mounted displays, such as helmet mounted display systems, as used by personnel in, for example, medicine, the emergency services, the military and virtual reality gamers for providing hands-free visual data.

### BACKGROUND TO THE INVENTION

Head-up displays have been common in attack aircraft for several decades, with a CRT or similar located below an inside face of the cockpit windshield with optics suitable for superimposing an image upon said inside face, which serves as a combining mirror. Problems associated with such designs arose from: i) their size and the limited instrument panel space; ii) the displayed information was stationary with respect to an axis, usually aligned along the longitudinal axis of the aircraft; and, iii) the images were presented within a limited field of view. The first modern HMDs were developed in the United Kingdom in the early 1950's; but it was not until the 1970s, that their use became widespread.

A typical modern head mounted display (HMD) has either one or two small displays with lenses and semi-transparent mirrors embedded in a helmet, eye-glasses or visor. The display units are miniaturized and may include one or more Cathode Ray Tubes (CRT), Liquid Crystal Digital (LCD), or other types of planar display. This is in stark contrast to the first helmet mounted displays as originally conceived in the First World War; GB106461 (A B Pratt) teaches of a helmet equipped with a gun fired from the head of a marksman. However, the primitive technology has advanced to such an extent that HMDs are now in widespread use by the pilots of military aircraft, in medicine, in search and rescue applications, sports and other fields.

U.S. Pat. No. 3,923,370 discloses a helmet with a CRT, unfortunately, such CRTs were necessarily small in size, were necessarily operated at safe voltages that were less than optimal for brightness purposes and generally produced dim images with poor resolution. Further, despite the small size, heat and weight problems associated with the CRT contributed to pilot fatigue.

Later types of helmet mounted head-up displays have been developed with the CRT replaced to a non-critical portion of the cockpit, with an optical fibre bundle coupling the CRT with the pilot's visual faculties, as described in U.S. Pat. No. 4,439,755. In turn this development has been replaced by the use of flat screen technology.

Modern head-up display systems generally include an image source such as a flat screen which provides images of various symbols for the representation of information generated by an electronic computer. From the image source, the light rays travel through an optical system onto a combining element situated in the pilot's field of vision such as a helmet or interposed between the pilot's head and the front of the wind screen. The element subsequently transmits real world images and reflects symbology images by means of collimated light into the eyes of the pilot.

Simply, head up displays and helmet mounted displays project head-directed sensor imagery and/or fire control symbology onto the eye, usually superimposed upon a see-through view of the outside world.

Due to the increasing complexity of aircraft instrumentation, pilots have been burdened with numerous monitoring activities, even during normal operations. Flight information from the cockpit instruments will typically include many discrete bits of data which need to be checked repeatedly, such as, torque, altitude, heading, attitude. However, for flying in an operational mode, the pilot cannot afford to divert his attention to any in-cockpit instrument, lest he be surprised by an unexpected obstacle or threat in his path.

Nintendo's Virtual Boy was the first portable game console capable of displaying “true 3D graphics” out of the box. Most video games are forced to use monocular cues to achieve the illusion of three dimensions on a two-dimensional screen, but the Virtual Boy was able to create a more accurate illusion of depth through the effect known as parallax. In a manner similar to using a head-mounted display, the user looks into an eyepiece made of neoprene on the front of the machine, and then an eyeglass-style projector allows viewing of the monochromatic (in this case, red) image.

Helmet mounted displays offer the potential for enhanced situation awareness and effectiveness. However, the design and implementation of developments are not without problems and limitations. Virtually every HMD suffers from one or more deficiencies, such as high head-supported weight, centre of mass (CM) off-sets, inadequate exit pupil, limited field of view (FOV), low brightness, low contrast, limited resolution, fitting problems, and low user acceptance. Of the potential problems with HMDs, none are more troublesome than those associated with the interfacing of the system with the human user, whose wide range in head and facial anthropometry makes this arguably the greatest task of all, requiring HMD designs to have significant flexibility in user adjustment.

In particular, a reduction in size of the optics has the inevitable consequence of reducing the exit pupil or Ramsden disc of a pupil forming

HMD. The Ramsden disc is the area in space where all the light rays pass; however, it often is pictured as a two-dimensional hole. To obtain the full FOV, the viewing eye must be located at (within) the exit pupil. Conversely, if the eye is totally outside of the exit pupil, none of the FOV is visible.

### OBJECT TO THE INVENTION

The present invention seeks to provide an improved head up display. The present invention also seeks to provide an improved head mounted display system. The present invention seeks to provide a head up display operable to provide a full field of view irrespective of eye position. The present invention also seeks to provide a flexible, customisable head mounted display system.

### SUMMARY OF THE INVENTION

In accordance with a first aspect of the present invention, there is provided a head up display apparatus comprising a signal processing system,

the signal processing system comprising an image projector for projecting an image to a partially reflective screen, said screen being configured substantially in front of an eye of a user of the display apparatus,

the apparatus further comprising a beam steering arrangement for steering the projected image substantially at an exit pupil of the system such that the projected image becomes directed upon the screen, and a pupil tracking arrangement for tracking a pupil of the user's eye,

the pupil tracking arrangement comprising at least one light detector and a mirror arrangement, and at least one mirror actuator which is responsive to signals from said at least one light detector to effect a repositioning of the mirror arrangement, such that the projected image remains directed at the pupil of the user as the user adjusts their line of sight.

The partially reflective screen is commonly referred to as a reflective combiner. Conveniently, the beam steering optics or the steering mirror is conveniently placed at or near an intermediate image whereby to minimise the change in aberrations in the final image as the exit pupil is steered to different positions.

The pupil tracking device may comprise light detectors directed towards a pupil of the user of the display, a pivot mirror arrangement and pivot mirror actuators responsive to signals from said light detectors, such that in response to signals from said light detectors, the image from the imaging optics the can be steered into alignment with the axial focus of the user of the display. The light detectors may comprise either linear detectors or digital detectors.

The pupil tracking device may comprise light detectors directed towards a pupil of the user of the display, and a spatial light modulator mirror, such that in response to signals from said light detectors, the image from the imaging optics can be steered into alignment with the axial focus of the user of the display.

Preferably, the image projector which projects the image onto the screen, such as a windshield of an aircraft or visor of some head-gear to be worn by some personnel, comprises a spatial light modulator. Alternatively, the image projector comprises a liquid crystal display (LCD).

In accordance with a second aspect of the present invention, there is provided a method of operating a head up display comprising a signal processing system, a beam steering arrangement, a screen and a pupil tracking arrangement comprising at least one light detector, a mirror arrangement and at least one mirror actuator, the method comprising the steps of:

projecting an image onto the screen

tracking the pupil of the user's eye using the pupil tracking arrangement and steering the projected image substantially at an exit pupil of the system using the beam steering arrangement, such that the projected image becomes directed upon the screen,

repositioning the mirror arrangement using the mirror actuators in response to signals received from the at least one light detector, such that the projected image remains directed at a pupil of the user as the user adjusts their line of sight.

The present invention provides a head up display such as a head mounted device which, using simple optical devices, enables downsizing of the optical components, together with a reduced exit pupil diameter, to enable lighter and more advanced head mounted systems to be fabricated. Application of the head up display includes military, civilian law enforcement, fire-fighters, gamers and the like.

### BRIEF DESCRIPTION OF THE FIGURES

Reference shall now be made to the Figures as shown in the accompanying drawing sheets, wherein:

FIG. 1 illustrates a display system of a known head mounted device;

FIG. 2 illustrates light ray paths in a head mounted device according to an embodiment of the present invention;

FIG. 3 is a flow diagram of the processes controlling a spatial light modulator according to an embodiment of the present the invention;

FIG. 4 is a schematic illustration of a display system according to an embodiment of the present invention;

FIGS. 5a is a schematic illustration of an eye tracking systems; and,

FIGS. 5b is a schematic illustration of an alternative eye tracking system.

### DETAILED DESCRIPTION OF PREFERRED EMBODIMENT

There will now be described, by way of example only, the best mode contemplated by the inventor for carrying out the present invention. In the following description, numerous specific details are set out in order to provide a complete understanding to the present invention. It will be apparent to those skilled in the art, that the present invention may be put into practice with variations of the specific. Specific reference shall be made to head mounted displays, but there is a wider applicability of the present invention to head up displays in general.

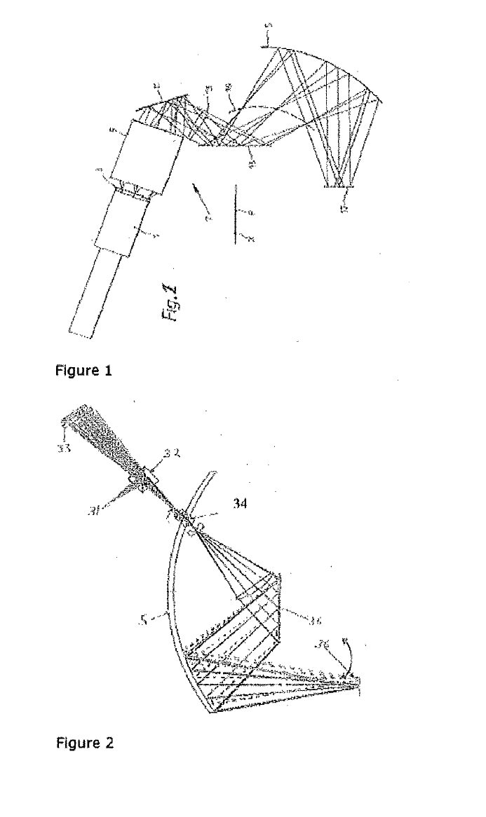

Referring now to a FIG. 1 of the drawings, there is illustrated a known cathode ray tube (CRT) head mounted display system. The display system is a binocular system and utilises two display systems (only one of which is illustrated in FIG. 1) according to an embodiment of the invention, one for each eye of a user of the system.

The display system for each eye comprises a miniature CRT 1 comprising a screen 3, upon which there is produced a real image of the display to be presented to the wearer of the helmet (not shown). The image is superimposed upon a spherical visor 5 mounted on the helmet. Light rays from the screen 3 pass first through a relay lens arrangement 7 comprising a lens group 9, a plane fold mirror 11, and a lens 13. Light rays exiting the lens 13 are directed in a general rearwards and downwards direction towards a forwards facing plane mirror 15 mounted at a central brow position on the helmet, i.e. centrally above the helmet face aperture. The mirror 15 is disposed in a generally vertical plane so as to reflect the light rays forwards and downwards, toward a region of the internal, concavely curved surface of the visor 5, for reflection thereat to the left or right eye position 17 of the wearer of the helmet.

The lens arrangement 7 and lens 13 are positioned and designed to produce a real image of the display on the screen 3 at the principal wavefront 19 of the concave reflecting surface constituted by the internal surface of the visor 5, which image contains equal and opposite optical aberrations to those produced by subsequent reflection at the visor 5. Due to the close proximity of the wavefront 19 to the eye position 17, the helmet wearer is provided at each eye with a large instantaneous field of view of a collimated virtual image of the display on the screen 3, superimposed on the forward scene viewed through the visor 5.

As is apparent from FIG. 1, the optical axis of the optical system lies in a plane. This plane is arranged to contain the centre of curvature X of the visor 5. As a result, whilst the light rays reflected at visor 5 are subject to off-axis aberration in the plane of the optical axis, they are on-axis in planes orthogonal to the optical axis plane. It will be appreciated that whilst depicted as geometrically flat in FIG. 1, the plane is in fact folded by the mirror 11. The purpose of the mirror 11 is to allow the components of the system, more particularly the lens group 9 and CRT 1, to be positioned closely around the helmet wearer's head.

To maintain their positions the various components of the system are mounted on a frame member (not shown) which is, in turn, secured to the outside of the shell (not shown) of the helmet (not shown) around the face aperture, as further described below. The frame member can be made of a rigid material which is capable of holding the optical components in their required relative positions against vibration, for example and is designed to have thermal expansion characteristics which compensate for the thermal expansion of the visor 5. A suitable material is a hybrid composite of carbon, aramid and glass fibre bound in an epoxy resin, and the frame member is suitably constructed of laminated sections, at orientations selected and arranged to give the required thermal and mechanical performance.

The frame member can provide three locating surfaces for the CRT and relay lens arrangements of each optical system, which components 1 and 7 of each system constitute a unit housed in a casing (not shown). The brow mirror 15 is also conveniently mounted on the frame member, on its forward side. Accordingly, the mirror 15 can be accurately pre-positioned on a frame (not shown) so that it can be accurately secured in position on the frame member. The visor 5 can also be conveniently pivotally mounted with respect to the frame member.

As the viewer moves back from the exit pupil or virtual exit aperture of the system, the field of view (FOV) will decrease. When the exit pupil of the HMD is larger than an entrance pupil of the viewer's eye, the eye can move around without loss of retinal illumination or FOV. The main advantage of a relayed pupil forming system is the use of the extra optical path length to form fit the HMD to the head.

Properties associated with the exit pupil characteristics are position, diameter and shape. Within the limitation of other design confounds, e.g., size, weight, complexity, and cost, the exit pupil should be as large as possible. Known types of integrated helmet and display systems have circular exit pupils of typically 10-15 mm diameter, with some systems with exit pupils with diameters as large as 20 mm. Since the exit pupil is the image of an aperture stop in the optical system, the shape of the exit pupil is generally circular and, therefore, its size is given as a diameter. However, concurrent with the miniaturisation of optical components, particularly with the use of diffraction limited laser light sources, conveniently acting upon an SLM for data transfer purposes, the exit pupil has become small, being around 1 mm or so in diameter. As will be appreciated, although the field of view remains the same, its visibility is lost; even slight movement of the user of the helmet will result in images falling outside the field of view of the user of the helmet.

What is of importance in HMDs is the actual physical distance from the plane of the last physical element of the system to the exit pupil, a distance called the physical eye relief or the eye clearance distance. This distance should be sufficient to allow use of corrective spectacles, nuclear, biological and chemical (NBC) protective masks, and oxygen mask, as well as, accommodate the wide variations in head and facial anthropometry. This has been a continuous problem with, in particular, the United States Integrated Helmet and Display Sighting System, where the optical eye relief value (10 mm) is greater than the actual eye clearance distance. This is due to the required diameter of the HDU objective lens and the bulk of the barrel housing.

In a typical aviation scenario, an external scene is acquired by a sensor, converted into an electrical signal, reproduced on a display, and then relayed optically to the eye(s). Within our definition of an HMD, the display which first reproduces the scene imagery, prior to relaying it to the eye, is referred to as the image source. Early designs of HMD utilised CRT of typically 25 mm diameter. When the concept of HMDs was first seriously pursued, the CRT was the only established display technology available. CRTs have remained the display of choice due to their attributes of low cost, easy availability, dependability, and good image quality. Newer technologies are collectively referred to as flat panel (FP) technologies, due to their flat display surface and thin physical profile. Displays based on FP technologies offer characteristics which counter the deficiencies of CRT displays. Flat panel displays (FPDs) have a greatly reduced physical profile, low power and voltage requirements, low heat output, and low weight. While types of image sources are not limited to CRTs and FP technologies, these are the most likely candidates for near-future systems. It is useful to note that the United States Aviator's Night Vision Imaging System (ANVIS) is perhaps the most common, but the weight of the helmet arrangement could be as much as 22 KG, the device being a binocular image intensifier device with an exit pupil of 12 mm; a more recent design, namely the Integrated Helmet and Display Sighting System (IHADSS) has a reduced weight relative to the ANVIS HMD but has a 10 mm exit pupil.

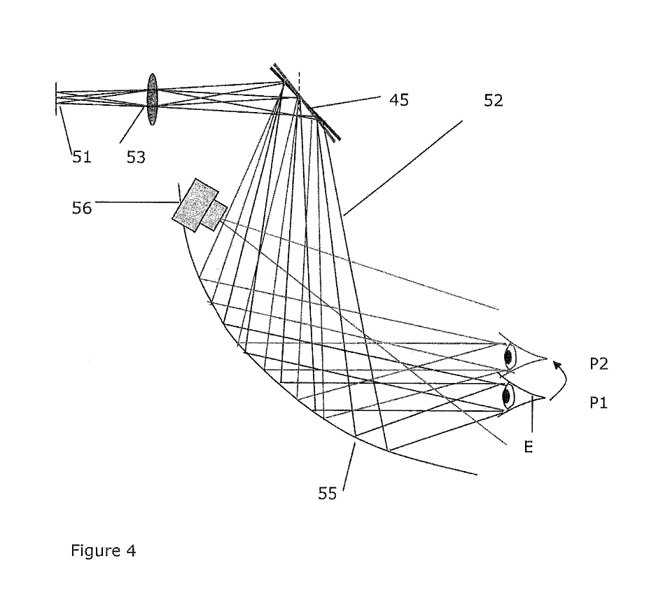

Referring now to FIG. 2, there is shown a schematic view of a helmet mounted display in accordance with an embodiment of the invention. A diffraction limited laser source is provided and a beam therefrom 31 is directed towards a polarising beam-splitter cube 32, which reflects the beam onto a spatial light modulator SLM, 33. The SLM 33 is activated to provide image information which passes through the cube 32, focussed by optical path elements 34, onto a pivoting brow mirror 35. Sensor means detailed with respect to FIG. 4 below, ensure that the small exit pupil is maintained within the field of view of the eye to which the beam is directed.

Accordingly, there will be a substantial coincidence of the nominal intermediate image with the beam steering optics, whether a steerable mirror is employed or other means as will be detailed below whereby to allow eye relief adjustment. It is also important to note that in the knowledge of the axial direction of the eye, then aberrations of the image, due for example the screen, can be taken into account, if computer generated holographs or similar are employed as is the case of the example described above, which utilises a spatial light modulator.

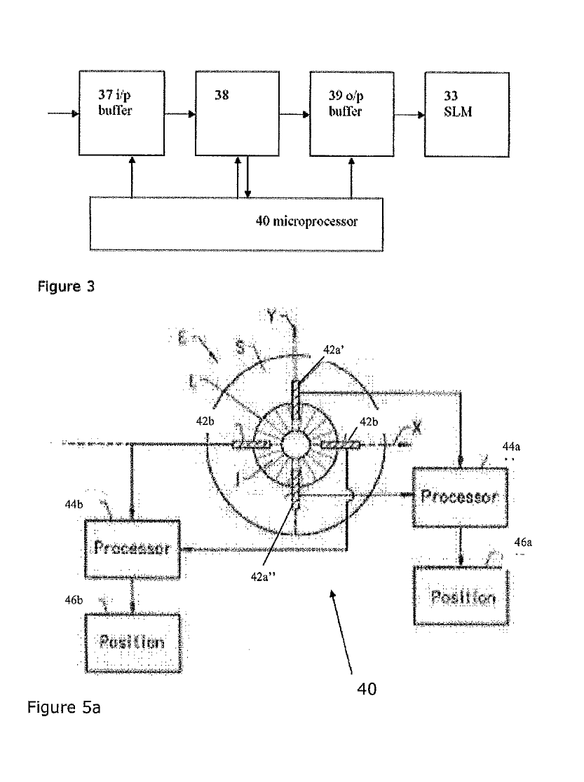

Referring now to FIG. 3, there is shown a flow diagram of the components of a data input flow for a spatial light modulator 33. Data from one or more sensors (not shown) which is to be displayed as an image on the HMD, is fed into an input buffer 37, which 55 under the control of micro-processor unit 40, outputs image frame data, namely data acquired during a period of time known as the frame period, to a holographic processor unit 38. The holographic processor phase modulates the image frame data and subjects the same to Fourier processing and quantisation. The processed image data corresponding to a particular frame period is then transferred to an output buffer 39 and subsequently to the SLM 33, as a series of discrete packets of sub-frame data. It will be appreciated that whilst the example shown here is of a Fourier projector but the video source could be a more conventional video projection system

The input to the system of FIG. 3 is preferably image data from the relevant system monitors (not shown). Each input buffer 37 preferably comprises dual-port memory such that data is written into the input buffer and read out from the input buffer simultaneously. The data corresponding to the sub-frames are outputted from the aforementioned output buffer and supplied to SLM 33 or other suitable display device.

Referring now to FIG. 4 of the drawings, there is shown a process involved in tracking the exit pupil of the system, to follow the eye and in particular the pupil of a users eye. The video source 51 is shown as a conventional source where light rays 52 project an image into the system, passing through a collimating lens 53 before being reflected by a beam steering mirror 45. The video source 51 could also be a holographic (Fourier) projector as shown in FIG. 2. The mathematics involved in relation to the processes involved is quite simple; reference can be made to look up tables defined when the systems is calibrated.

The camera 56 is directed towards the eyeball of the eye (E); the image from the camera can be utilised to define a frame of reference for a particular position of the iris and pupil of the eye. The position of the eye E is then calculated in the frame of reference of the camera picture. A previously calculated and calibrated look up table can then be used to convert the camera frame of reference to the x, y coordinates in the helmet frame of reference (with the nominal design eye position at 0,0). In actual fact, a polynomial fit to a look up table can also be employed. Having determined the position of the eye E, the beam steering mirror 45 is then adjusted by servo motors for example (not shown), to adjust the reflective angle of the mirror 45; again reference can be made to a further look-up table, in order to determine the position to place the exit pupil. It is preferred that the beam steering optics, such as the pivot or steering mirror 45 is placed at or near the intermediate image. This is found to minimise any change in aberrations in the final image, as the exit pupil is steered to different positions.

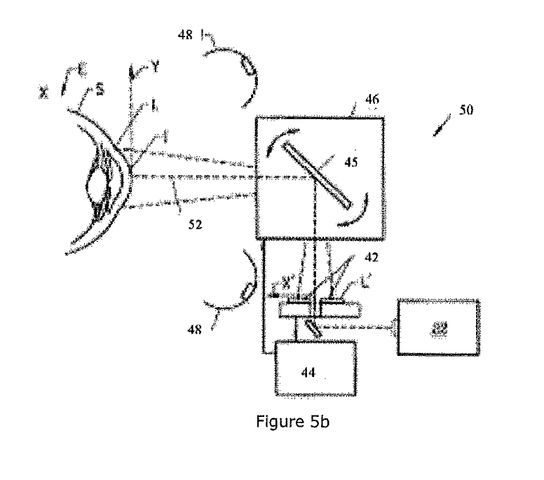

The beam steering mechanism may be quite different to that described above. However, if a Fourier projector is used so that any slight aberration correction can be applied to the hologram, then x, y position needs to be known to calculate the aberration correction, which would also be in the form of a look up table. Referring to FIGS. 5a and 5b of the drawings, the process may be described in a number of steps, such as:

1) The eye E moves its position;

2) The camera 56 monitors eyeball movement;

3) A reference position for the new eye position is determined;

4) The extent of movement required by the mirror 45 is determined;

5) The fold mirror mechanism is steered into a new position; and

6) The exit pupil of the image moves to the new eye position.

FIG. 5a shows a basic feedback mechanism for a pupil tracking arrangement 40 which used to track lateral movements of an eye E using a series of linear bulk photodetectors 42. Detectors 42 are arranged in coaxial pairs, and the signals from the detectors 42 are compared and manipulated by a processor 44 which controls a repositioning mechanism 46. Repositioning system 46 is arranged to adjust the alignment between eye E and detectors 42 based on the signals from the processor 44. Detectors 42 each have an elongate light sensing area and are radially oriented with respect to the eye E. While detectors 42 are illustrated in FIG. 4 as being superimposed on eye E, it should be understood that the detectors will often sense a position of eye E based on an image of the eye. Hence, descriptions of the relative positions of detectors 42 relative to the structures and features of eye E will often, in practice, be carried out using an image of the eye. For example, eye E includes a sclera S and an iris I with a limbus L defining the border therebetween. Photodiodes 42 are disposed around the sclera S at a radial position which extends “across” limbus L to extend from iris I to sclera S, so that each detector 42 measures light from both the substantially white, relatively bright sclera S, and from the much darker iris I. Linear detectors 42 will typically comprise elongate silicon photodiodes, which have time constants of tens of picoseconds.

The processors 44 are arranged to compare signals generated from a pair of detectors 42a, 42b. The detectors are typically arranged either side of the iris I, substantially parallel to a diameter thereof and are long enough to measure lateral movements of eye E along one dimension. Accordingly, the detectors are much longer than their width. Processor 44a measures a position of iris I of eye E along an axis Y by comparing signals generated from a first pair of detectors 42a. When eye E moves upward, the amount of sclera S adjacent first detector 42a′ of the pair will decrease, while the amount of the sclera adjacent the second detector 42a″ will increase. Conversely, the darker iris will increasingly be exposed to first detector 42a′, and will have a decreasing exposure to second detector 42a″. As a result, the total illumination signal produced by first detector 42aa′ will decrease, while the signal produced by the second detector 42a″ will increase. By comparing these signals, processor 44a can sense that eye E has moved in the positive Y direction, and can also measure the amount and velocity of that movement based on the quantitative difference in signals, and by the rate of change of this difference, respectively.

Repositioning mechanisms 46a, 46b will generally effect realignment between detectors 42a, 42b, respectively, and eye E, based on the positioning signal from processor 44a, 44b, respectively. To separate the one-dimensional feedback loops along X and Y axes as illustrated in FIG. 5a, the positioning mechanism 46a attached to processor 44a is arranged to affect only the alignment along axis Y, and the positioning mechanism 46b attached to processor 44b is arranged to affect only the alignment along axis X. A variety of mechanisms may be used to provide such one-dimensional repositioning.

FIG. 5b illustrates an HMD system 50 for following iris I movement incorporating the elements of tracking system 40 of FIG. 5a. The HMD system 50 also includes a light source 22 comprising the beam reflected from the SLM 33. This light beam, being the data beam can be utilised in the feedback mechanism. Light beam 52 and linear detectors 42 are aligned relative to eye E by repositioning mechanism 46. In this embodiment, repositioning mechanism 46 makes use of a pivoting mirror 45 to alter a position of an image of eye E upon linear detectors 42. The image beam incident upon the mirror and the mirror are coincident (or closely coincident) by virtue of the imaging optics. In other words, a limbus image L′ superimposed on detectors 42 is aligned relative to the detectors by pivoting mirror 45 as shown.

Imaging and sensing can be enhanced by illuminating eye E with light energy appropriate for measurement by detectors 42, as described above. Such illumination can be provided by oblique illuminators 48. The portions of tracking system 40 illustrated in FIG. 5a will generally maintain alignment between laser beam 52 and eye E only along axis X. A second pair of detectors 42 coupled to an independent processor 44 and a substantially independent repositioning mechanism 46 can be used to track the eye during movements into and out of the plane of the drawing.

An alternative sensing system could employ discrete, digital linear array photodiodes, whereby to provide additional spatial information. Specifically, the digital nature of a linear array would provide absolute edge location, rather than just relative measurements of the iris position. The accuracy of a digital position sensing system will depend on the pixel dimensions of the linear array, taking into account classical optical constraints such as field of view, magnification, and the like.

The beam steering optics may be configured in a still further fashion by the use of a spatial light modulator. In common with the mechanically operated mirror, as described above, the spatial light modulator receives incident light from the imaging optics of the head up display apparatus. In contrast to the mechanically operated mirror, the incident light is refracted by virtue of phase changes being effected, whereby to cause the light beam to be steered, wherein the reflected output signals from the spatial light modulator are also refracted towards the pupil. The principle of operation outlined with reference to Figure three can be implemented in a similar fashion.

Simply, a head up display, such as an HMD, projects head-directed sensor imagery and/or fire control symbology onto the eye, usually superimposed over a see-through view of the outside world. The overall goal of a head up display is to effectively interface the user of the display with his surroundings, be it an aeroplane, a fellow crewmember search and rescue team, or a games console and video screen. In particular, HMDs offer the potential for enhanced situation awareness and effectiveness. However, their design and implementation are not without problems and limitations. Virtually every HMD, concept or fielded system, suffers from one or more deficiencies, such as high head-supported weight, centre of mass off-sets, inadequate exit pupil, limited FOV, low brightness, low contrast, limited resolution, fitting problems, and low user acceptance. Of the potential problems with HMDs, none are more troublesome than those associated with the interfacing of the system with the human user. The present invention provides a solution to one of the most basic problem—that of ensuring that the image present for view by the eye of the wearer is seen, despite the wide variation in head and facial anthropometry; the design enables head mounted displays to be flexible in design, with many adjustments possible for optimum fit. The images are projected onto a reflective or partially reflective portion of a lens and are viewable without the user having to alter his forward line-of-sight.

Whilst the example detailing the invention is a head mounted device, the principles of the invention can be applied to other conventional systems—by using a smaller simpler optics that gives a small exit pupil and then scan it. This will also give a much brighter image as image luminance is proportional to exit pupil size—so a scanned system whose un-scanned exit pupil is only 1 mm diameter will be 400 times brighter than a conventional one with a 20 mm exit pupil (assuming the light usage is optimised in both cases).

1. A head up display apparatus comprising a signal processing system,
the signal processing system comprising an image projector for projecting an image to a partially reflective screen, said screen being configured substantially in front of an eye of a user of the display apparatus,
the apparatus further comprising a beam steering arrangement for steering the projected image substantially at an exit pupil of the system such that the projected image becomes directed upon the screen, and a pupil tracking arrangement for tracking a pupil of the user's eye,
the pupil tracking arrangement comprising at least one light detector and a mirror arrangement, and at least one mirror actuator which is responsive to signals from said at least one light detector to effect a repositioning of the mirror arrangement, such that the projected image remains directed at the pupil of the user as the user adjusts their line of sight.

2. A head up display apparatus according to claim 1, wherein the image projector comprises a spatial light modulator and control electronics for generating the image and projecting the image onto the screen.

3. A head up display apparatus according to claim 1, wherein the light detectors comprise linear detectors.

4. A head up display apparatus according to claim 1, wherein the light detectors comprise digital detectors.

5. A head up display apparatus according to claim 1, wherein beam steering is effected by the use of spatial light modulators.

6. A head up display apparatus according to claim 1, wherein the image projector comprises a processor and a wireless receiver for receiving data from a transmitting device.

7. A head up display apparatus according to claim 1, wherein the image projector is arranged to communicate with a transmitting device via a cable which couples the image projector to the transmitting device.

8. A head up display apparatus according to claim 6 wherein the transmitting device comprises a sensor for sensing data to be presented by the display apparatus.

9. A head up display apparatus according to claim 1, wherein the screen comprises one of or both glasses of a pair of goggles, one of or both glasses of a pair eye glasses or a visor associated with an item of head gear.

10. A head up display apparatus according to claim 1, wherein the apparatus is mounted upon a cockpit of a vehicle.

11. A head up display apparatus according to claim 1, wherein the apparatus is mounted upon an item of headgear.

12. A method of operating a head up display comprising a signal processing system, a beam steering arrangement, a screen and a pupil tracking arrangement comprising at least one light detector, a mirror arrangement and at least one mirror actuator, the method comprising the steps of:
projecting an image onto the screen
tracking the pupil of the user's eye using the pupil tracking arrangement and steering the projected image substantially at an exit pupil of the system using the beam steering arrangement,
such that the projected image becomes directed upon the screen,
repositioning the mirror arrangement using the mirror actuators in response to signals received from the at least one light detector, such that the projected image remains directed at a pupil of the user as the user adjusts their line of sight.

13. A head up display apparatus according to claim 7, wherein the transmitting device comprises a sensor for sensing data to be presented by the display apparatus.
